(19) United States
(12) Patent Application Publication
(10) Pub. No.: US 2010/0051562 A1
(43) Pub. Date: Mar. 4, 2010

(54) Funnel with reusable filter media for liquids

(76) Inventor: Tyler Jameson Coleman, Houston, TX (US)

Correspondence Address: Tyler Coleman, 19811 Gulfwind Ct., Houston, TX, 77094, US

(21) Appl. No.: 12/547,779

(22) Filed: Aug. 26, 2009

Related U.S. Application Data
(60) Provisional application No. 61/092,662, filed on Aug. 28, 2008.

(51) Int. Cl. B01D 29/085

(52) U.S. Cl. 210/767; 210/474

(57) ABSTRACT

A funnel with reusable filter media for liquids includes: a funnel adapted to receive the liquid, having a first end with a first opening and a second end with a second opening, the first opening larger than the second opening; a filter between the first opening and the second opening; and an outer surface adapted to rest against the container. The funnel and the filter cooperate so that the liquid passes into the first opening, through the filter, out the second opening, and into the container.

### RELATED APPLICATIONS

The present application claims benefit of priority from U.S. Provisional Application No. 61/092,662, filed Aug. 28, 2008, which is incorporated herein by reference in its entirety.

### FIELD OF THE INVENTION

The present invention generally relates to filters, and more specifically, to a funnel with reusable filter media for liquids.

### BACKGROUND OF THE INVENTION

People who cook, bake, or fry foods use liquids to do so. It would be desirable to filter these liquids for re-use.

### SUMMARY OF THE INVENTION

In one aspect of the present invention, a device for filtering liquid into a container includes: a funnel adapted to receive the liquid, having a first end with a first opening and a second end with a second opening, the first opening larger than the second opening; a filter between the first opening and the second opening; and an outer surface adapted to rest against the container; wherein the funnel and the filter cooperate so that the liquid passes into the first opening, through the filter, out the second opening, and into the container.

In another aspect of the present invention, a device for filtering a liquid and directing the fluid into a container includes: a first reservoir adapted to receive the liquid; a second reservoir, smaller than the first reservoir, coupled to the first reservoir so that the liquid flows from the first reservoir into the second reservoir; a surface of the first reservoir that surrounds the second reservoir, the surface adapted to rest against the container; and a third reservoir smaller than the second reservoir, coupled to the second reservoir and having a filter so that the liquid flows from the second reservoir into the third reservoir, through the filter and out of the third reservoir; wherein the device rests against the container and the liquid is filtered through the device and into the container

In yet another aspect of the present invention, a method for filtering a liquid and directing the liquid into a container includes: transmitting the liquid into a funnel, the funnel having a first end with a first opening and a second end with a second opening, the first opening larger than the second opening; passing the liquid into the first opening, through the filter, out the second opening, and into the container; and resting an outer surface of the funnel against the container; thereby supporting the funnel while filtering the liquid.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is a side view of an embodiment of the present invention;

FIG. 3 is an enlarged detail view taken from FIG. 2;

FIG. 4 is a top view of an embodiment of the present invention;

FIG. 5 is a bottom view of an embodiment of the present invention; and

FIG. 6 is a cross section of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention generally relates to a reusable thin wall funnel with a reusable filter media bottom for potable, edible, cooking, baking or frying liquid filtration as well as to direct the clean liquid into a container, receptacle, reservoir or original storing vessel.

An embodiment of a filter funnel combination will allow users to reuse various potable, edible, cooking, baking or frying liquids. The thin wall funnel will sit atop a container and provide a large opening to pour the aforementioned liquids into. The liquid will follow down the decreasing size of the funnel until it reaches the filter media. The filter media will be a sieve or screen, fine enough to remove solid particulate matter from the liquid being filtered. This filtration will allow the liquid to be reused. After the liquid passes through the filter media, it will leave the funnel into a desired container. This funnel filter has two components that are fused together as one. There are no inaccessible parts, moving or separate pieces, making it easy to clean and keep sanitary. This filter funnel is used to clean liquids used in culinary preparation.

An embodiment of the present invention can be made up of the following elements: a reusable thin wall funnel; and a reusable filter media. These elements are connected as follows: the filter media is welded inside the funnel over the funnel exit; furthermore the filter media can be connected to the funnel exit by but not limited to gluing, sliding into place, using epoxy, tape, fusing with heat, melting them together, hermetically sealing, ultrasonic sealing, screwing into place, using screws to hold in place or snapping or locking into place.

Further, an embodiment of this invention may have a rubberized funnel entry lip cover, filleted corners on the staggered edges, or a rounded face on the end of the exiting neck.

In various embodiments, the funnel may have a long exiting neck. The funnel can have a staggered or tiered design, where the tiers are reservoirs to hold the liquid. The funnel can be made of various materials such as but not limited to wood, plastic, steel (or any other metal or metal alloy), but stainless steel is preferable. The funnel material may be heat resistant, non-corrosive, lead-free and non-toxic. The entry hole to the funnel may be larger than the exit hole of the funnel.

In embodiments, the filter media can be made of various materials, such as but not limited to aluminum, steel, any other metal or metal alloy, or any other sufficiently resilient material, but stainless steel is preferable. The filter media material may be heat resistant, non-corrosive, lead-free and non-toxic. The filter media may be attached to the funnel by various means, such as but not limited to welding, snapping in place, sliding into place or threaded/screwed into place.

In an embodiment, there are two components to this filtering apparatus. There is the thin wall funnel part, which can be made by stamping the funnel from sheet metal. The thin wall funnel can also be made by forging, casting (including centrifuge), blow molding, and rapid prototype, lathing or pressing. The other component is the filter media that can be made from but is not limited to wire mesh that can be welded, attached by gluing, sliding into place, using epoxy, tape, fusing with heat, melting them together, hermetically sealing, ultrasonic sealing, screwing into place, using screws to hold in place or snapping or locking into place over the exit hole of the funnel. The filter media mesh size should be small enough to filter out particles, but not so small as to have a noticeable or drastic impact on the flow rate through the filter.

In an embodiment, the two components are attached together. The filter media is attached to the thin wall funnel, such as by welding, gluing, sliding into place, using epoxy, tape, fusing with heat, melting them together, hermetically sealing, ultrasonic sealing, screwing into place, using screws to hold in place or snapping or locking into place, although it is preferred to weld it into place. Once the liquid is assured to be cool, the funnel filter is placed into the uncapped container and the liquid is then poured into the filter funnel. The clean liquid will pass back into a container, receptacle, reservoir or original storing vessel.

In other embodiments, the general shape and filtering media can be changed. The filter may have a long exit neck to ensure the funnel from rotating out of a container. The funnel can also have a staggered of tiered design to hold the funnel and filter in place on top of a container. The funnel could alternatively have a tapered shape to hold it on top of a container. The filter media can be made of wire mesh but can also be made of other metal configurations. The filter media could also be made of but not limited to plastic, rubber or cloth. The filter media can be welded into place or alternatively it can be snapped, slid, locked or threaded/screwed into place. An embodiment of the invention is made to sanitarily filter solid particulate matter for culinary liquids. This filter is also made to withstand heat and made from two components into one. It filters fine solid particulate matter and it will also sit independently atop a container, receptacle, reservoir or original storing vessel. The size of the funnel filter allows captured particles to be contained before needing to discard the unwanted matter, as well as allowing flow even after the filter media is covered.

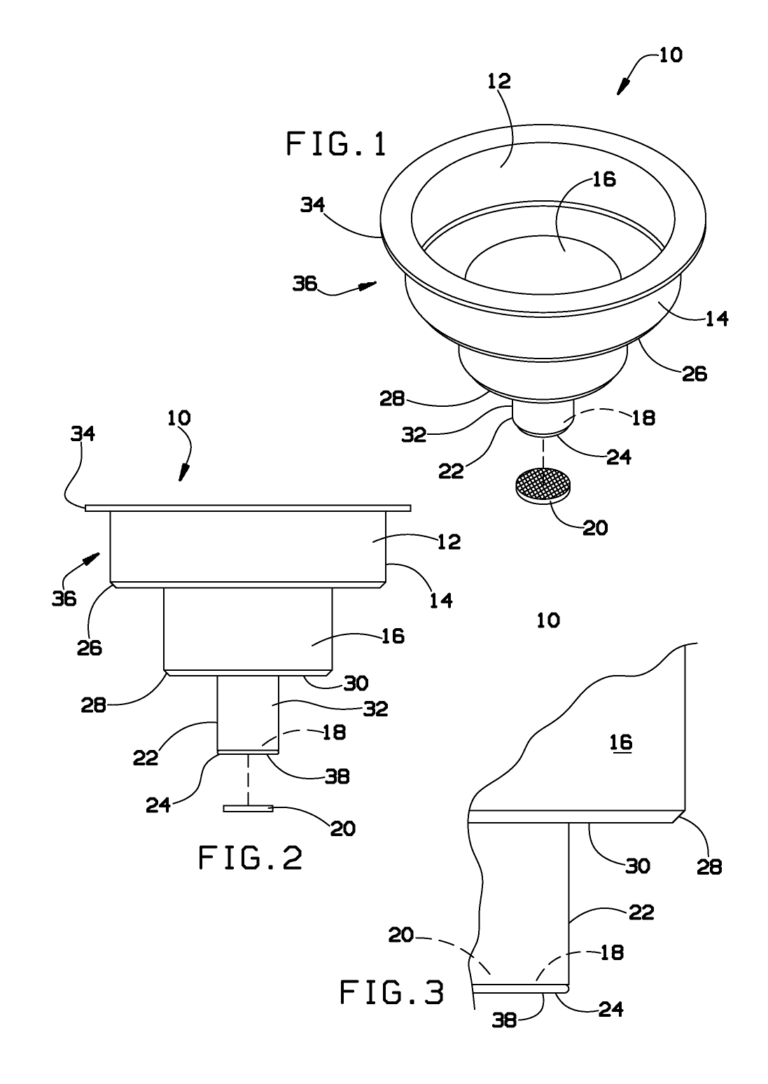

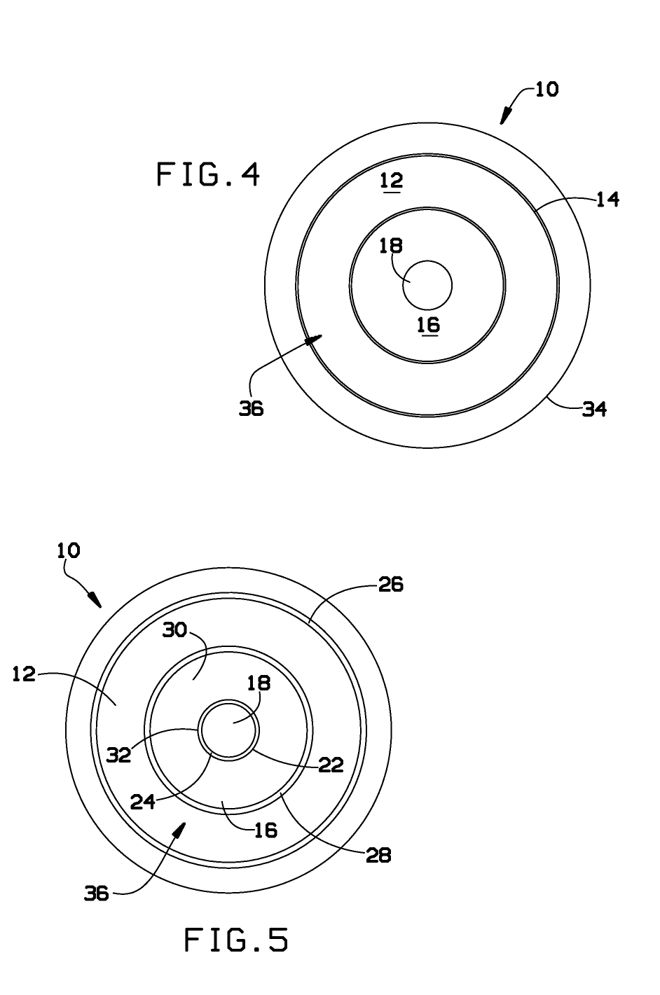

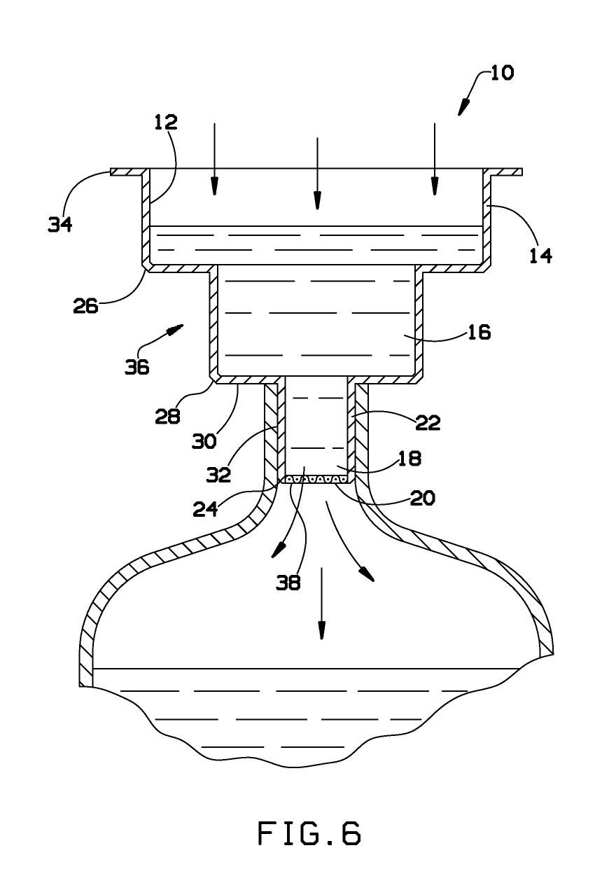

As depicted in FIGS. 1, 2 and 3, an embodiment of the present invention 10 includes a thin wall 14 generally funnel-shaped body 36 having a large reservoir 12 that receives the liquid and a medium sized reservoir 16 that lies against a receptacle (not shown) on a receptacle surface 30. A small reservoir 22 fits into the receptacle while the neck 32 holds the funnel filter in place as the fluid flows through the exit opening 18 and the filter media 20 (exploded from the figure to show separate filter media and funnel) where the filter media is attached along the neck perimeter 38. The largest reservoir has its corner filleted 26 as well as the medium reservoir has its corner filleted 28 where the neck of the filter is rounded at the end 24. The lip of the funnel 34 is also filleted.

An embodiment of a reusable thin wall funnel with reusable filter media for potable, edible, cooking, baking or frying liquids filtration includes: a thin wall funnel; and a filter media. The filter media is attached to the exit of the funnel, to be disposed within an opening of a container, receptacle, reservoir or original storing vessel that is acceptable to store ingestible liquids. Said filter funnel will have a funnel shape in that the fluid will be received in the larger opening and the filtered fluid will exit the smaller opening, which is completely covered by an affixed filter media as the filter media will have a larger diameter than said exit opening. The funnel shape will include a first cylindrical reservoir adjunct with a second smaller cylindrical reservoir with a diameter between 50% and 90% that of the largest cylindrical section and a third cylindrical reservoir with a diameter between 50% and 90% that of the second cylindrical reservoir.

An embodiment of the invention further includes a filter media completely spanning the funnel exit opposite the funnel entrance.

An embodiment of the invention further includes a filter media made of stainless steel wire mesh.

An embodiment of the invention further includes a thin wall funnel body formed of stainless steel.

An embodiment of the invention further includes a funnel having a smooth finish interior as well as exterior.

An embodiment of the invention further includes a filter media attached to the funnel by affixing the perimeter of the filter media of wire mesh to the funnel, where the filter covers the exit of the funnel entirely.

An embodiment of the invention further includes two separate cylindrical reservoirs where the reservoirs each are approximately half the length of the funnel.

An embodiment of the invention further has all sharp corners filleted.

In an embodiment, the funnel shaped filter will have a neck that fits down into a container, receptacle, reservoir or original storing vessel of culinary liquid. The neck will flare out to be larger diameter than the hole in the container to allow the filter to securely sit on the container without assistance. The neck will go deep enough into the container so that the filter cannot tilt out of the hole. The filtration will be gravity driven as the liquid flows through the funnel exit, through a wish mesh filter, which catches solid contaminants.

It should be understood, of course, that the foregoing relates to exemplary embodiments of the invention and that modifications may be made without departing from the spirit and scope of the invention as set forth in the following claims.

We claim:

1. A device for filtering liquid into a container, comprising:
a funnel adapted to receive the liquid, having a first end with a first opening and a second end with a second opening, the first opening larger than the second opening;
a filter between the first opening and the second opening; and
an outer surface adapted to rest against the container;
wherein the funnel and the filter cooperate so that the liquid passes into the first opening, through the filter, out the second opening, and into the container.

2. The device of claim 1 further comprising:
a first tier of the funnel adapted to receive the liquid;
a second tier of the funnel, smaller in diameter than the first tier, coupled to the first tier so that the liquid flows from the first tier into the second tier; and
a lower surface of the first tier, adapted to rest upon a rim of the container so that the container supports the device.

3. The device of claim 2 further comprising:
a first tier of the funnel adapted to receive the liquid, the first tier having a lower surface adapted to rest upon a rim of the container;
a second tier of the funnel, smaller in diameter than the first tier, the second tier small enough to extend into the container; and
a third tier of the funnel, smaller in diameter than the second tier, the third tier containing the filter;
wherein the liquid flows from the first tier into the second tier, from the second tier into the third tier, through the filter, and then out of the device.

4. The device of claim 1, wherein the filter is a reusable mesh that is fine enough to remove solid particulate matter from the liquid.

5. A device for filtering a liquid and directing the fluid into a container, comprising:
a first reservoir adapted to receive the liquid;
a second reservoir, smaller than the first reservoir, coupled to the first reservoir so that the liquid flows from the first reservoir into the second reservoir;
a surface of the first reservoir that surrounds the second reservoir, the surface adapted to rest against the container; and
a third reservoir smaller than the second reservoir, coupled to the second reservoir and having a filter so that the liquid flows from the second reservoir into the third reservoir, through the filter and out of the third reservoir;
wherein the device rests against the container and the liquid is filtered through the device and into the container.

6. The device of claim 5, wherein the filter is a fine mesh that removes solid particulate matter from the liquid.

7. A method for filtering a liquid and directing the liquid into a container, comprising:
transmitting the liquid into a funnel, the funnel having a first end with a first opening and a second end with a second opening, the first opening larger than the second opening;
passing the liquid into the first opening, through the filter, out the second opening, and into the container; and
resting an outer surface of the funnel against the container;
thereby supporting the funnel while filtering the liquid.

8. The method of claim 7, further comprising:
receiving the liquid into a first tier of the funnel; and
transmitting the liquid from the first tier into a second tier of the funnel, the second tier smaller in diameter than the first tier.

9. The method of claim 7, further comprising:
receiving the liquid into a first tier of the funnel, the first tier having a lower surface; and
transmitting the liquid from the first tier into a second tier of the funnel, the second tier smaller in diameter than the first tier, the second tier small enough to extend into the container; and
transmitting the liquid from the second tier into a third tier of the funnel, the third tier smaller in diameter than the second tier, the third tier containing the filter; and
resting the funnel upon a rim of the container so that the container supports the funnel.

10. The method of claim 7, further comprising:
providing a reusable mesh filter that is fine enough to remove solid particulate matter from the liquid.
